(19) United States
(12) Patent Application Publication
(10) Pub. No.: US 2026/0229660 A1
(43) Pub. Date: Aug. 6, 2026

(54) ELECTRIC POWER STORAGE MODULE

(71) Applicant: KABUSHIKI KAISHA TOYOTA JIDOSHOKKI, Kariya-shi, Aichi (JP)

(72) Inventors: Mikiya KURITA, Aichi (JP); Fumihiko ISHIGURO, Aichi (JP); Takayuki HIROSE, Aichi (JP); Masahiro YAMADA, Aichi (JP); Tomohiro NAKAMURA, Aichi (JP)

(73) Assignee: KABUSHIKI KAISHA TOYOTA JIDOSHOKKI, Kariya-shi, Aichi (JP)

(21) Appl. No.: 19/147,875

(22) PCT Filed: Nov. 29, 2023
(86) PCT No.: PCT/JP2023/042778

§ 371 Date: Jul. 14, 2025

(30) Foreign Application Priority Data
Jan. 23, 2023 (JP) 2023-008161

(51) Int. Cl. H01M 50/184; H01M 4/02; H01M 50/105; H01M 50/186; H01M 50/271; H01M 50/46

(52) U.S. Cl. CPC H01M 50/184; H01M 50/105; H01M 50/186; H01M 50/271; H01M 50/46; H01M 2004/029

(57) ABSTRACT

An electric power storage module includes an electrode stack in which a plurality of electrodes each including a current collector are stacked in a first direction, a sealing body provided on the electrode stack so as to surround the electrode stack as viewed from the first direction and configured to seal a plurality of internal spaces formed between the current collectors adjacent to each other in the first direction, an exterior film configured to surround and contain the electrode stack and the sealing body, and a cover member contained in the exterior film so as to be interposed between the sealing body and the exterior film, configured to cover a side surface of the sealing body extending in the first direction, and fixed to the sealing body.

### TECHNICAL FIELD

The present disclosure relates to an electric power storage module.

### BACKGROUND ART

Patent Literature 1 discloses a battery. The battery includes a power generating element in which a plurality of electrodes are stacked, and an exterior film for housing the power generating element. A cover is provided at an end of the power generating element to suppress deformation of the power generating element and short-circuit of the power generating element due to deformation of the exterior film when external stress is applied. The cover is fitted and fixed to the end of the power generating element.

### CITATION LIST

### Patent Literature

Patent Literature 1: Japanese Unexamined Patent Publication No. 2000-123801

### SUMMARY OF INVENTION

### Technical Problem

However, in an electric power storage module including an electrode stack in which the electrodes are stacked as described above, there is a possibility that a part of the electrode stack is deformed or damaged when the cover is fixed to the electrode stack.

The present disclosure provides an electric power storage module capable of suppressing deformation and damage of an electrode stack.

### Solution to Problem

An electric power storage module according to one aspect of the present disclosure includes an electrode stack in which a plurality of electrodes each including a current collector are stacked in a first direction, a sealing body provided on the electrode stack so as to surround the electrode stack as viewed from the first direction and configured to seal a plurality of internal spaces formed between the current collectors adjacent to each other in the first direction, an exterior film configured to surround and contain the electrode stack and the sealing body, and a cover member contained in the exterior film so as to be interposed between the sealing body and the exterior film, configured to cover a side surface of the sealing body extending in the first direction, and fixed to the sealing body.

In the electric power storage module, the cover member is interposed between the sealing body and the exterior film. The cover member is fixed not to the electrode stack but to the sealing body surrounding the electrode stack. Thus, the deformation and damage of the electrode stack by the cover member are suppressed.

The sealing body of one example may include a plurality of communication holes configured to communicate with the plurality of internal spaces and formed to have openings in the side surface, and a frame portion configured to protrude from the side surface in a second direction intersecting the side surface so as to surround the openings of the plurality of communication holes, and the cover member may cover the frame portion. In this configuration, since the contact of the frame portion with the exterior film is suppressed, the deformation and damage of the exterior film is suppressed by the frame portion.

The cover member of one example may be fixed to the frame portion. The cover member is fixed to the frame portion, and thus, the contact of the frame portion with the exterior film is suppressed.

The cover member of one example may include an attachment member welded to the frame portion and a cover body fixed to the attachment member by sandwiching the attachment member. In this configuration, the frame portion can be reliably sealed by having a dedicated component welded to the frame portion.

The cover member may include a first cover member configured to cover a region of the side surface where the frame portion is formed, and a second cover member configured to cover a region of the side surface where the frame portion is not formed, and the first cover member and the second cover member may be coupled to each other. The cover member is divided into a plurality of parts, and thus, occurrence of warpage or the like in each cover member is suppressed.

### Advantageous Effects of Invention

According to the present disclosure, it is possible to provide the electric power storage module capable of suppressing the deformation and damage of the electrode stack.

### BRIEF DESCRIPTION OF DRAWINGS

FIG. 1 is a schematic perspective view of an electric power storage module of one example.

FIG. 2 is a schematic diagram illustrating a side surface of a module body constituting the electric power storage module.

FIG. 3 is a sectional view taken along line II-II of FIG. 2.

FIG. 4 is a schematic sectional view of the electric power storage module of one example.

FIG. 5 is a schematic sectional view of the electric power storage module of one example.

FIG. 6 is a perspective view illustrating a coupling portion between cover members of one example.

FIG. 7 is a perspective view illustrating the cover member of one example.

FIG. 8 is a schematic sectional view of an electric power storage module of another example.

FIG. 9 is a schematic sectional view of an electric power storage module of yet another example.

FIG. 10 is a schematic sectional view of an electric power storage module of yet another example.

FIG. 11 is a schematic diagram illustrating a side surface of a module body constituting an electric power storage module of yet another example.

FIG. 12 is a perspective view illustrating a part of the side surface of the module body of FIG. 11.

FIG. 13 is a perspective view illustrating a cover member of another example.

FIG. 14 is a perspective view illustrating a state where the cover member of FIG. 13 is attached to the module body.

FIG. 15 is a sectional view taken along line XV-XV of FIG. 14.

### DESCRIPTION OF EMBODIMENTS

Hereinbelow, an embodiment will be described in detail with reference to the drawings. Note that, in description of the drawings, the same or equivalent elements are given the same reference signs, and redundant description thereof might be omitted. Furthermore, in the description, a Cartesian coordinate system defined by an X-axis, a Y-axis, and a Z-axis illustrated in the drawings can be referred to.

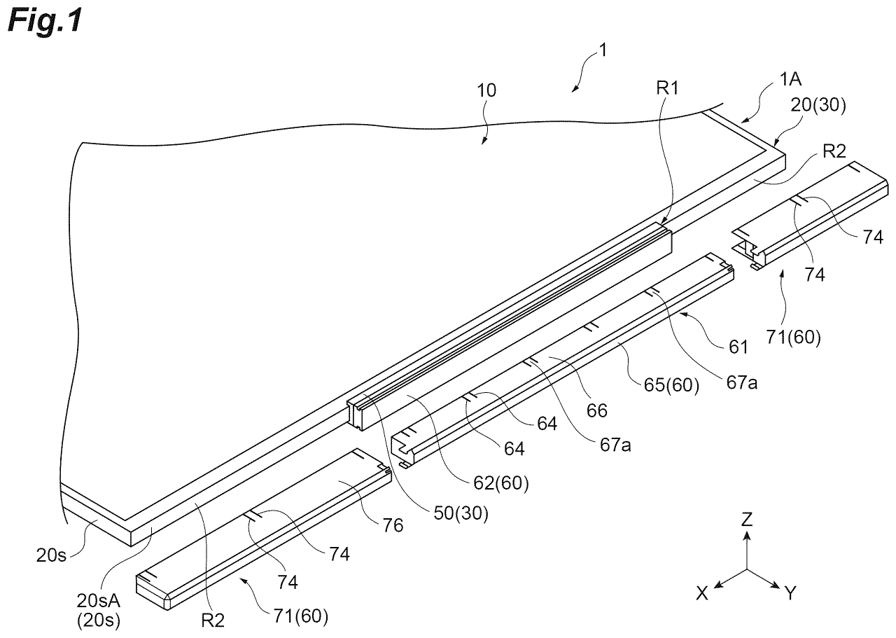

FIG. 1 is a schematic perspective view illustrating an electric power storage module according to the present embodiment. In the electric power storage module 1 illustrated in FIG. 1, an exterior film 90 is omitted, and a cover member 60 is disassembled. The electric power storage module 1 is, for example, an electric power storage module used for a battery of one of various vehicles including a forklift, a hybrid vehicle, and an electric vehicle. The electric power storage module 1 is, for example, a secondary battery such as a nickel-metal hydride secondary battery or a lithium-ion secondary battery. The electric power storage module 1 may be an electric double-layer capacitor or an all-solid-state battery. Herein, a case of the electric power storage module 1 as a lithium-ion secondary battery is illustrated.

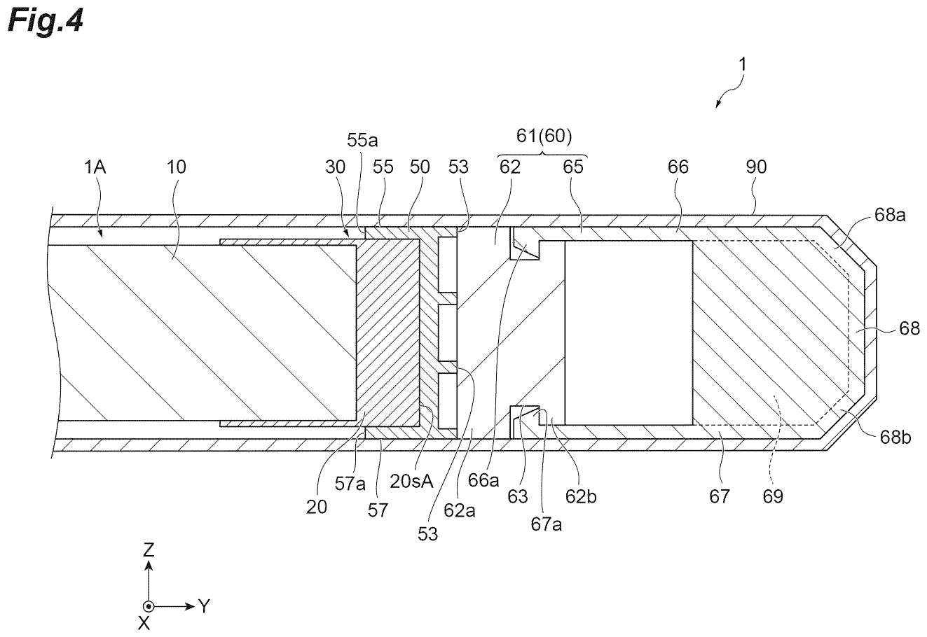

The electric power storage module 1 includes a module body 1A, a cover member 60, and the exterior film 90 (see FIG. 4). The module body 1A includes an electrode stack 10 and a sealing body 30 surrounding the electrode stack 10. The module body 1A has a rectangular shape as viewed from a Z-axis direction (first direction), and has four outer side surfaces 20s extending in the Z-axis direction. One outer side surface 20sA of the four outer side surfaces 20s includes a region R1 functioning as a liquid pouring port surface and a region R2 adjacent to the region R1. The cover member 60 of one example includes a first cover member 61 and a second cover member 71. In the illustrated example, although a size and a detailed shape are different, two second cover members 71 having the same basic configuration such as an attachment method attached to the module body 1A are provided.

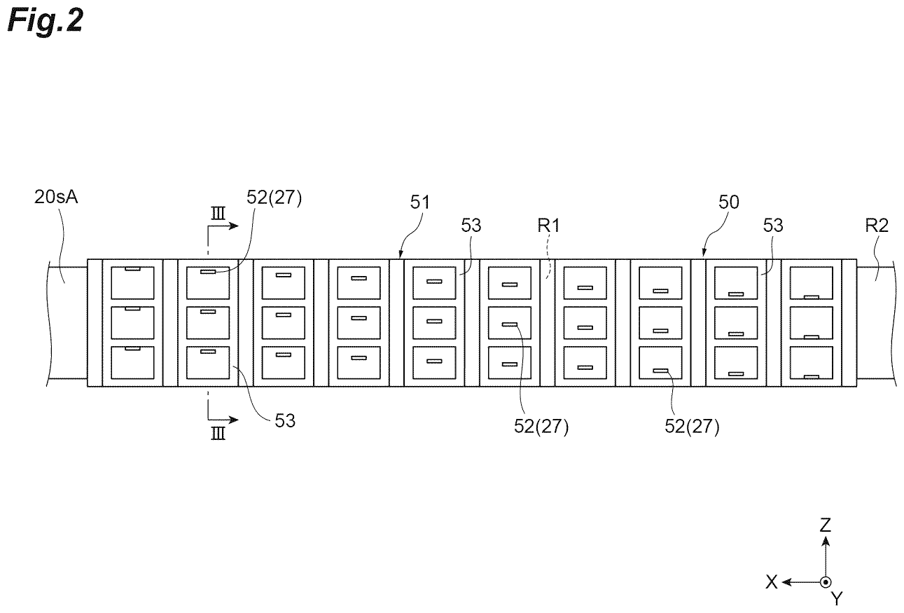

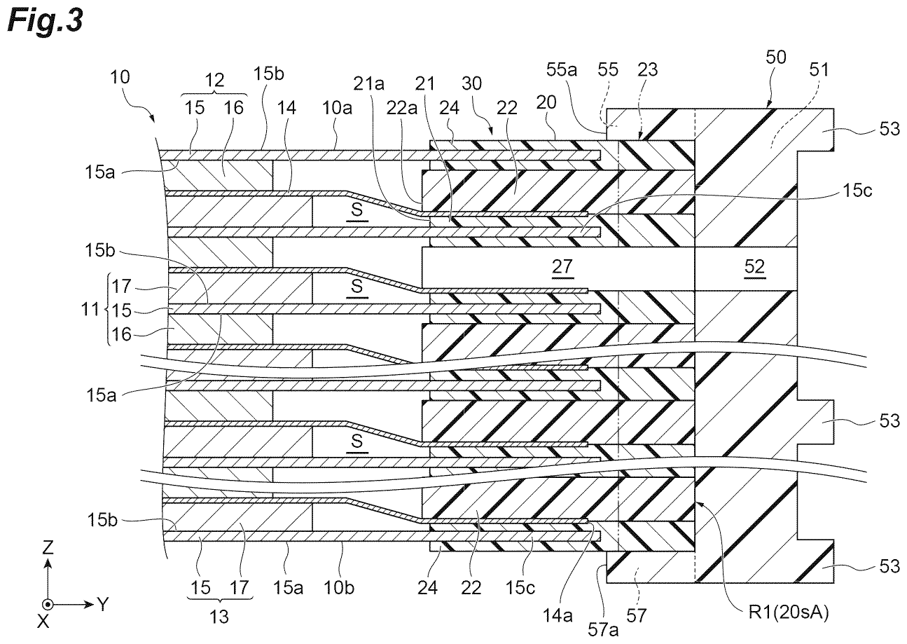

FIG. 2 is a schematic diagram illustrating a side surface of the module body constituting the electric power storage module. FIG. 3 is another schematic sectional view of an example of the module body. Note that, FIG. 2 illustrates an outer side surface 20sA of the module body 1A, and FIG. 3 illustrates a section taken along line III-III of FIG. 2. As illustrated in FIG. 3, the electrode stack 10 includes a plurality of electrodes stacked in the Z-axis direction. The Z-axis direction is the direction of electrode stacking and the height direction of the electric power storage module 1. The plurality of electrodes include a plurality of bipolar electrodes 11, a positive terminal electrode 12, and a negative terminal electrode 13. A separator 14 is interposed between the electrodes adjacent to each other.

Each bipolar electrode 11 includes a current collector 15, a positive electrode active material layer 16, and a negative electrode active material layer 17. The current collector 15 has a rectangular shape as viewed from the Z-axis direction, and has a sheet shape. The active material layer (positive electrode active material layer 16 or negative electrode active material layer 17) is provided at a center of the current collector 15 as viewed in the Z-axis direction, and is not provided on a peripheral edge portion 15c of the current collector 15. The negative electrode active material layer 17 is provided on the other surface 15b of the current collector 15. The plurality of bipolar electrodes 11 are stacked on one another such that the positive electrode active material layer 16 of one bipolar electrode 11 and the negative electrode active material layer 17 of another bipolar electrode 11 adjacent to each other in the stacking direction face each other. Here, one surface 15a of the current collector 15 is a surface facing one side in the Z-axis direction (a side on which the negative terminal electrode 13 is arranged in FIG. 3). The other surface 15b of the current collector 15 is a surface facing the other side in the Z-axis direction (a side on which the positive terminal electrode 12 is arranged in FIG. 3).

The positive electrode active material layer 16 and the negative electrode active material layer 17 each have a rectangular shape as viewed from the Z-axis direction. The negative electrode active material layer 17 is slightly larger than the positive electrode active material layer 16 as viewed from the Z-axis direction. In a plan view viewed from the Z-axis direction, an entire formation region of the positive electrode active material layer 16 is positioned in a formation region of the negative electrode active material layer 17.

The positive terminal electrode 12 includes a current collector 15 and a positive electrode active material layer 16 provided on one surface 15a of the current collector 15. The positive terminal electrode 12 does not include the positive electrode active material layer 16 and the negative electrode active material layer 17 on the other surface 15b of the current collector 15. That is, an active material layer is not provided on the other surface 15b of the current collector 15 of the positive terminal electrode 12. The positive terminal electrode 12 is stacked on one of the bipolar electrodes 11 at an end of the electrode stack 10 on the one side of the Z-axis direction. The positive terminal electrode 12 is stacked on the bipolar electrode 11 such that the positive electrode active material layer 16 thereof faces the negative electrode active material layer 17 of the bipolar electrode 11.

The negative terminal electrode 13 includes a current collector 15 and a negative electrode active material layer 17 provided on the other surface 15b of the current collector 15. The negative terminal electrode 13 does not include the positive electrode active material layer 16 and the negative electrode active material layer 17 on the one surface 15a of the current collector 15. That is, an active material layer is not provided on the one surface 15a of the current collector 15 of the negative terminal electrode 13. The negative terminal electrode 13 is stacked on the bipolar electrode 11 at an end of the electrode stack 10 on the other side opposite to the one side where the positive terminal electrode 12 is provided in the Z-axis direction. The negative terminal electrode 13 is stacked on the bipolar electrode 11 such that the negative electrode active material layer 17 thereof faces the positive electrode active material layer 16 of the bipolar electrode 11. Note that, in the present embodiment, the current collectors of the bipolar electrode 11, the positive terminal electrode 12, and the negative terminal electrode 13 are denoted by the same reference signs as the current collector 15, but the current collectors of the bipolar electrode 11, the positive terminal electrode 12, and the negative terminal electrode 13 may be the same or different from each other.

The separators 14 are arranged between adjacent bipolar electrodes 11, between the positive terminal electrode 12 and the bipolar electrode 11, and between the negative terminal electrode 13 and the bipolar electrode 11. Each separator 14 is interposed between the positive electrode active material layer 16 and the negative electrode active material layer 17, and isolates the positive electrode active material layer 16 and the negative electrode active material layer 17 from each other. Each separator 14 allows charge carriers such as lithium ions to pass while preventing a short circuit due to contact between adjacent electrodes.

The current collector 15 is a chemically inactive electric conductor that causes a current to continuously flow through the positive electrode active material layer 16 and the negative electrode active material layer 17 during discharge or charge of the lithium-ion secondary battery. A material of the current collector 15 is, for example, a metal material, a conductive resin material, a conductive inorganic material, or other materials. Examples of the conductive resin material include a resin obtained by adding a conductive filler to a conductive polymer material or a non-conductive polymer material as necessary. The current collector 15 may include a plurality of layers. In this case, each layer of the current collector 15 may include the above-described metal material or conductive resin material.

A covering layer may be formed on a surface of the current collector 15. The covering layer may be formed by, for example, a known method such as plating or spray coating. The current collector 15 may have, for example, a plate shape, a foil shape (for example, metal foil), a film shape, a mesh shape, or other shapes. Examples of the metal foil include an aluminum foil, a copper foil, a nickel foil, a titanium foil, and a stainless steel foil. The current collector 15 may be an alloy foil or a clad foil containing such metal as described. In a case where the current collector 15 has a foil shape, the thickness of the current collector 15 may be, for example, 1 μm to 100 μm. In the present embodiment, the current collector 15 is a foil in which an aluminum foil and a copper foil are integrated, or an aluminum foil.

The positive electrode active material layer 16 contains a positive electrode active material capable of occluding and releasing charge carriers such as lithium ions. Examples of the positive electrode active material include a lithium composite metal oxide having a stratified rock salt type structure, a metal oxide having a spinel structure, and a polyanionic compound. The positive electrode active material may be any material that can be used for the lithium-ion secondary battery. The positive electrode active material layer 16 may contain a plurality of positive electrode active materials. In the present embodiment, the positive electrode active material layer 16 contains olivine lithium iron phosphate (LiFePO₄) as a composite oxide.

The negative electrode active material layer 17 contains a negative electrode active material capable of occluding and releasing charge carriers such as lithium ions. The negative electrode active material may be any of a simple substance, an alloy, or a compound. Examples of the negative electrode active material include Li, carbon, and a metal compound. The negative electrode active material may be an element that can be alloyed with lithium, a compound thereof, or other materials. Examples of the carbon include natural graphite, artificial graphite, hard carbon (non-graphitizing carbon), and soft carbon (graphitizing carbon). Examples of the artificial graphite include highly oriented graphite and meso-carbon microbeads. Examples of the element that can be alloyed with lithium include silicon and tin. In the present embodiment, the negative electrode active material layer 17 contains graphite as a carbon-based material.

Each of the positive electrode active material layer 16 and the negative electrode active material layer 17 (hereinafter, also simply referred to as “active material layer” in some cases) may further contain a conductive auxiliary, a binder, an electrolyte (such as polymer matrix, ion conductive polymer, or electrolytic solution) for increase electric conductivity, a supporting electrolyte salt (lithium salt) for increasing ion conductivity, and the like, as necessary. The conductive auxiliary is added to increase the electric conductivity of each of the electrodes (the bipolar electrodes 11, the positive terminal electrode 12, and the negative terminal electrode 13). The conductive auxiliary is, for example, acetylene black, carbon black, graphite, or the like.

Examples of the binder include fluorine-containing resins such as polyvinylidene fluoride, polytetrafluoroethylene, and fluororubber, thermoplastic resins such as polypropylene and polyethylene, imide resins such as polyimide and polyamidimide, alkoxysilyl group-containing resins, acrylic resins such as acrylic acid and methacrylic acid, styrene-butadiene rubber (SBR), carboxymethyl cellulose, alginates such as sodium alginate and ammonium alginate, water-soluble cellulose ester crosslinked bodies, and starch-acrylic acid graft polymers. These binders can be used alone or in combination. For example, water, N-methyl-2 pyrrolidone (NMP), or the like is used as a solvent.

The separator 14 may be, for example, a porous sheet or a nonwoven fabric containing a polymer that absorbs and holds an electrolyte. Examples of a material of the separator 14 include polypropylene, polyethylene, polyolefin, and polyester. The separator 14 may have a single layer structure or a multilayer structure. The multilayer structure may have, for example, a ceramic layer or the like as an adhesive layer or a heat resistant layer. The separator 14 may be impregnated with an electrolyte. The separator 14 may include an electrolyte such as a polymer electrolyte or an inorganic electrolyte. Examples of the electrolyte with which the separator 14 is impregnated include a liquid electrolyte (electrolytic solution) containing a nonaqueous solvent and an electrolyte salt dissolved in the nonaqueous solvent, or a polymer gel electrolyte containing an electrolyte held in a polymer matrix.

In a case where the separator 14 is impregnated with the electrolytic solution, a known lithium salt such as LiClO₄, LiAsF₆, LiPF₆, LiBF₄, LiCF₃SO₃, LiN(FSO₂)₂, or LiN(CF₃SO₂)₂ may be used as the electrolyte salt. Furthermore, a known solvent such as cyclic carbonates, cyclic esters, chain carbonates, or chain esters may be used as the nonaqueous solvent. Note that, two or more of these known solvent materials may be used in combination.

The sealing body 30 includes a sealing body portion 20 and a reinforcing member 50. The sealing body portion 20 is formed in a frame shape in a peripheral edge of the electrode stack 10 in such a way as to form an outer edge of the electrode stack 10 as viewed from the Z-axis direction. The sealing body portion 20 can be joined to each of the one surface 15a and the other surface 15b of each current collector 15 on the peripheral edge portion 15c of the current collector 15. The sealing body portion 20 forms internal spaces S between the current collectors 15 adjacent to each other in the Z-axis direction, and seals each of the internal spaces S. An electrolytic solution (not illustrated) is contained in each internal space S. That is, the sealing body portion 20 defines the internal spaces S containing the electrolytic solution in cooperation with the current collectors 15 adjacent to each other in the Z-axis direction. The sealing body portion 20 can suppress the flowing of the electrolytic solution contained in the internal space S to the outside.

The sealing body portion 20 can suppress air, moisture, and the like from entering the internal space S from an outside of the electrode stack 10. The sealing body portion 20 can suppress leaking of gas generated at each electrode due to, for example, charge and discharge reactions or the like to an outside of the electric power storage module 1. Edge portions of the separators 14 are joined to the sealing body portion 20. The sealing body portion 20 contains an insulating material. Examples of a material of the sealing body portion 20 include various resin materials such as polypropylene, polyethylene, polystyrene, ABS resin, acid-modified polypropylene, acid-modified polyethylene, and acrylonitrile styrene resin.

An example of the sealing body portion 20 includes a plurality of sealing materials 21, a pair of end sealing materials 24, and a plurality of spacers 22. The sealing materials 21, the end sealing materials 24, and the spacers 22 may be frame-shaped members formed in sheet shapes. Furthermore, a welded end 23 is formed in the sealing body portion 20. Each sealing material 21 is frame-shaped as viewed from the Z-axis direction and is provided on the peripheral edge portion 15c of the current collector 15. The sealing material 21 is provided to extend from the one surface 15a to the other surface 15b of the corresponding current collector 15 through its end surface, and covers the peripheral edge portion 15c. That is, the sealing material 21 includes an inner portion overlapping the current collector 15 and an outer portion positioned outside an end edge of the current collector 15 as viewed from the Z direction on each of the one surface 15a and the other surface 15b of the current collector 15, and the outer portions of the pair of sealing materials 21 adjacent to each other with the current collector 15 interposed therebetween are connected to each other. The sealing materials 21 can be welded to at least one of the one surfaces 15a and the other surfaces 15b of the current collectors 15. The sealing material 21 of the present embodiment is welded to both the one surface 15a and the other surface 15b of the current collector 15.

The end sealing material 24 has a frame shape as viewed from the Z-axis direction, and is provided along the peripheral edge portion 15c of the current collector 15 constituting each of the positive terminal electrode 12 and the negative terminal electrode 13. Therefore, the end sealing materials 24 are arranged in such a way as to sandwich the plurality of sealing materials 21 in the Z-axis direction. The end sealing materials 24 can be welded to at least one of the one surfaces 15a and the other surfaces 15b of the current collectors 15. The end sealing materials 24 of the present embodiment are welded to both the one surfaces 15a and the other surfaces 15b of the current collectors 15.

The spacers 22 are frame-shaped as viewed from the Z-axis direction and are arranged along the peripheral edge portions 15c of the current collectors 15. The spacers 22 are arranged in such a way as to be interposed between the sealing materials 21 adjacent to each other in the Z-axis direction. Furthermore, the spacers 22 are arranged in such a way as to be interposed between the sealing materials 21 and the end sealing materials 24 adjacent to each other in the Z-axis direction. The spacer 22 can hold an interval between the current collectors 15 adjacent to each other in the Z-axis direction. That is, the spacers 22, the sealing materials 21, and the end sealing materials 24 define the internal spaces S between the adjacent current collectors 15.

The welded end 23 is formed by welding and integrating ends of the plurality of sealing materials 21, the pair of end sealing materials 24, and the plurality of spacers 22 on a side opposite the internal spaces S. The welded end 23 is frame-shaped and surrounds the electrode stack 10 as viewed from the Z-axis direction. A side surface of the welded end 23 on the side opposite the internal spaces S extends in the Z-axis direction and constitutes the outer side surface 20s of the sealing body portion 20. In other words, the sealing body portion 20 includes the outer side surface 20s on the side opposite the internal spaces S. The outer side surface 20s may be formed as a flat surface.

The sealing body portion 20 has a plurality of communication holes 27 communicating with the plurality of internal spaces S (see FIG. 3). As an example, the communication hole 27 is a cutout portion formed in the spacer 22, and is formed to penetrate the welded end 23. The communication hole 27 has one opening in the internal space S and the other opening in the outer side surface 20s of the sealing body portion 20. In the illustrated example, an opening is formed in the outer side surface 20sA.

The reinforcing member 50 is formed so as to overlap a region of the outer side surface 20sA where the communication hole 27 is formed. The reinforcing member 50 is molded in a predetermined shape to provide a plurality of liquid pouring ports communicating with the plurality of communication holes 27. The reinforcing member 50 is joined to the welded end 23. For example, the reinforcing member 50 is integrally joined to the welded end 23 by injection molding. The reinforcing member 50 as one example includes a body portion 51, a first overhang portion 55, and a second overhang portion 57.

The body portion 51 partially covers the outer side surface 20sA. For example, the body portion 51 covers the outer side surface 20sA in such a way as to include a region R1 where the plurality of communication holes 27 formed in the outer side surface 20sA are formed. As described above, the plurality of communication holes 27 communicate with the plurality of internal spaces S, respectively. In the example illustrated in FIG. 2, 30 communication holes 27 corresponding to 30 internal spaces formed between the current collectors 15 are discretely arranged in an X-axis direction and the Z-axis direction. More specifically, communication holes 27 corresponding to internal spaces of first to tenth layers from a positive terminal electrode 12 side are discretely arranged at equal intervals in the X-axis direction, and communication holes 27 corresponding to internal spaces of eleventh to twentieth layers and communication holes 27 corresponding to internal spaces of twenty-first to thirtieth layers are arranged in order in the Z-axis direction below the internal spaces of the first to tenth layers. The body portion 51 extends in a rectangular shape along the X-axis direction and the Z-axis direction to cover a region R3 where the 30 communication holes 27 are formed.

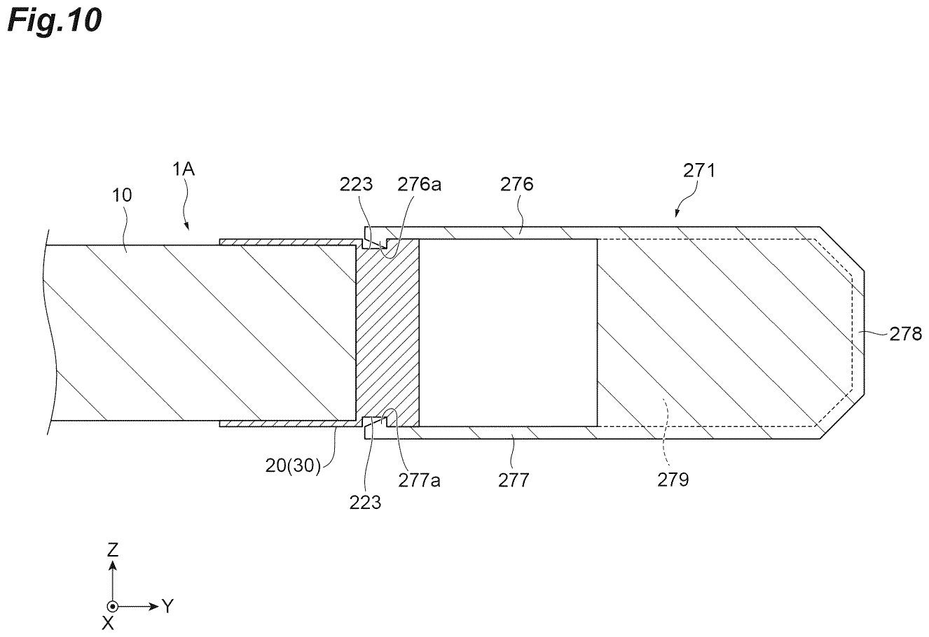

The body portion 51 is formed in a rectangular plate shape having a predetermined thickness in a Y-axis direction. The body portion 51 has openings 52 at positions corresponding to the communication holes 27. Furthermore, the body portion 51 includes a protruding frame portion 53 (frame portion) protruding from the outer side surface 20sA in the Y-axis direction (second direction) intersecting (orthogonal to) the outer side surface 20sA. The protruding frame portions 53 surround the openings 52 as viewed from the Y-axis direction, and function as partition walls separating the openings 52 from one another. In the example of FIGS. 2, 10 protruding frame portions 53 in which three spaces for separating three vertically arranged openings 52 from one another are formed are arranged in the X-axis direction.

In an example, each protruding frame portions 53 is used when an electrolytic solution is injected into the corresponding internal space S. When the electrolytic solution is injected, for example, a nozzle of a solution injection device is brought into close contact with a top surface of the protruding frame portion 53, and the electrolytic solution is introduced into the space of the protruding frame portion 53 from the nozzle. Accordingly, the electrolytic solution can thus be injected into the internal spaces S through the openings 52 and the communication holes 27.

The first overhang portion 55 and the second overhang portion 57 are formed by being connected to both end edges of the body portion 51 in the Z-axis direction. The first overhang portion 55 partially covers one end edge (a positive side in the Z-axis direction) of the welded end 23 in the Z-axis direction. For example, the first overhang portion 55 partially covers the end sealing material 24 joined to the positive terminal electrode 12. In the illustrated example, an end edge 55a of the first overhang portion 55 extends from the end edge of the welded end 23 to a position outside an inner edge 22a of the spacer 22 and an inner edge 21a of the sealing material 21 as viewed from the Z-axis direction. The first overhang portion 55 may be formed in a rectangular plate shape having the same length as the body portion 51 in the X-axis direction.

The second overhang portion 57 partially covers the other end edge (a negative side in the Z-axis direction) of the welded end 23 in the Z-axis direction. For example, the second overhang portion 57 partially covers the end sealing material 24 joined to the negative terminal electrode 13. In the illustrated example, an end edge 57a of the second overhang portion 57 extends from the end edge of the welded end 23 to the position outside the inner edge 22a of the spacer 22 and the inner edge 21a of the sealing material 21 as viewed from the Z-axis direction. The second overhang portion 57 may be formed in a rectangular plate shape having the same length as the body portion 51 in the X-axis direction.

Conductive members each functioning as a terminal for extracting current from the electric power storage module 1 may be arranged in and electrically connected to portions of the one surface 15a of the current collector 15 of the positive terminal electrode 12 and the other surface 15b of the current collector 15 of the negative terminal electrode 13 exposed from the sealing body portion 20. The conductive members are arranged between the plurality of electric power storage modules 1, and can be used to electrically connect adjacent electric power storage modules 1. Furthermore, in a case where a pair of restraint members (not illustrated) for restraining the electric power storage module 1 from the Z direction is arranged, a restraint load from the restraint members can be applied to the electrode stack 10 through the conductive members. Furthermore, cooling channels may be formed in the conductive members. The electric power storage module 1 can be cooled by circulating a cooling medium through the cooling channels formed in the conductive members.

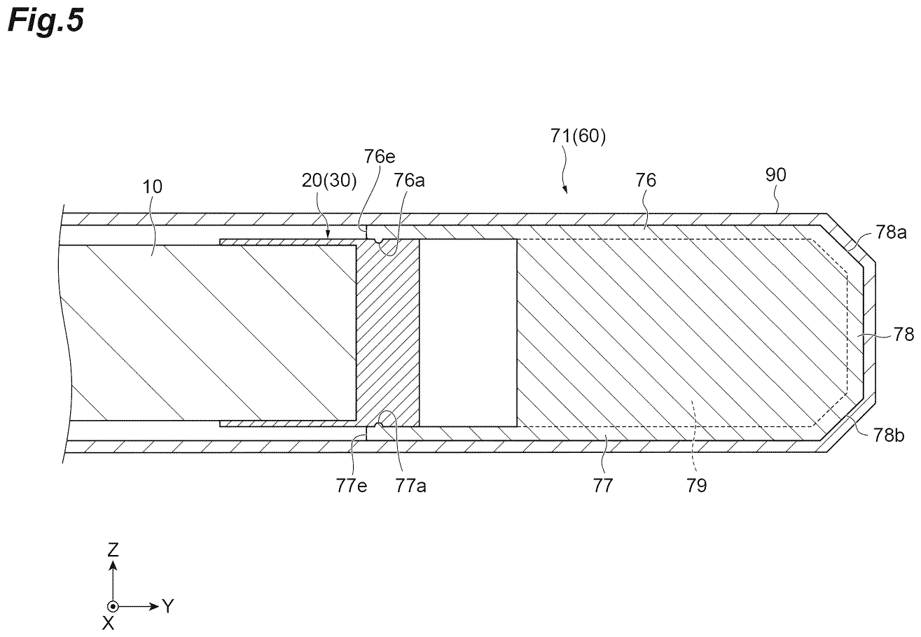

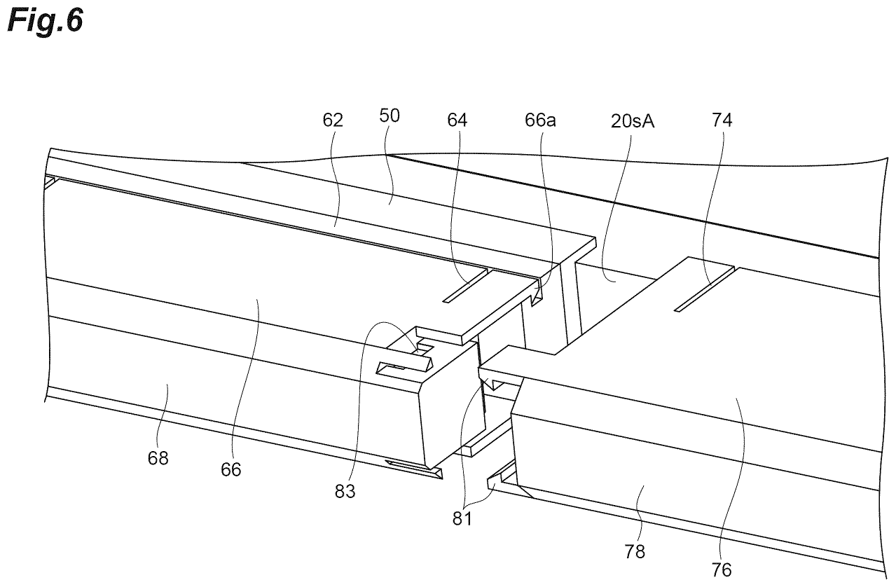

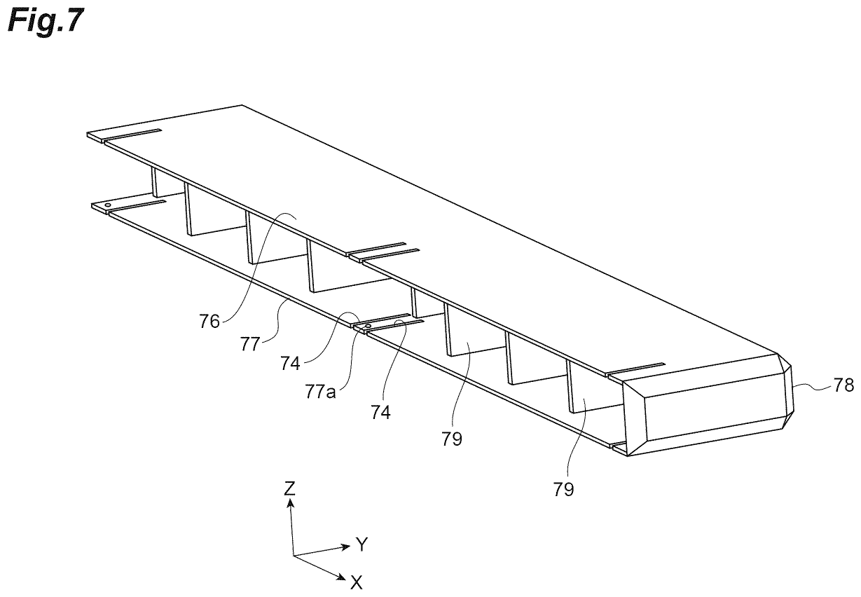

FIGS. 4 and 5 are schematic sectional views illustrating the electric power storage module as one example. FIG. 6 is a perspective view illustrating a coupling portion between the cover members as one example. FIG. 7 is a perspective view illustrating the cover member as one example. FIG. 4 is a sectional view of the electric power storage module 1 at a position where the first cover member 61 constituting the cover member 60 is provided, and FIG. 5 is a sectional view of the electric power storage module 1 at a position where the second cover member 71 constituting the cover member 60 is provided. The cover member 60 covers the outer side surface 20sA of the sealing body 30 and is fixed to the sealing body 30. The first cover member 61 covers a region of the outer side surface 20sA where the reinforcing member 50 is formed. The second cover member 71 covers a region of the outer side surface 20sA where the reinforcing member 50 is not formed.

As illustrated in FIG. 4, the first cover member 61 includes an attachment member 62 fixed to the sealing body 30 and a cover body 65 fixed to the attachment member 62. The attachment member 62 may be a resin member formed in a substantially rectangular plate shape. For example, a size of the attachment member 62 in the Z-axis direction may be the same as a size of the reinforcing member 50 in the Z-axis direction. Furthermore, a size of the attachment member 62 in the X-axis direction may be equal to a size of the reinforcing member 50 in the X-axis direction.

In one example, the attachment member 62 may be welded to the top surface of the protruding frame portion 53. The attachment member 62 is welded to the protruding frame portion 53, and thus, each of the 30 openings 52 partitioned by the protruding frame portion 53 is sealed. The attachment member 62 has groove portions 63 formed along the X-axis direction on both end surfaces in the Z-axis direction. A region 62a of the attachment member 62 closer to the module body 1A than the groove portion 63 may have the same size as the reinforcing member 50 in the Z-axis direction. A region 62b of the attachment member 62 farther from the module body 1A than the groove portion 63 may have a size smaller than the reinforcing member 50 in the Z-axis direction.

The cover body 65 as one example sandwiches the attachment member 62 from the Z-axis direction. For example, the cover body 65 includes a first wall portion 66 and a second wall portion 67 facing each other in the Z-axis direction, and a third wall portion 68 extending in an XZ plane so as to connect the first wall portion 66 and the second wall portion 67. A connection portion 68a between the first wall portion 66 and the third wall portion 68 and a connection portion 68b between the second wall portion 67 and the third wall portion 68 are formed in a chamfered shape in which corner portions are chamfered. The chamfered shape may be a C-chamfered shape or a R-chamfered shape (the illustrated example has a C-chamfered shape). That is, the corner portions (connection portions 68a and 68b) formed by the connection between the wall portions may be formed to be inclined obliquely or may be formed to be rounded.

The cover body 65 may be formed to have a hollow inside for weight reduction. In a case where the cover body 65 has a hollow inside, one or more reinforcing ribs 69 may be provided in the hollow inside. The rib 69 has a plate shape extending along a YZ plane, and connects the first wall portion 66 and the second wall portion 67 to each other. The rib 69 in the illustrated example is further connected to the third wall portion 68. The cover body 65 may include a plurality of ribs 69 at equal intervals in the X-axis direction. A position of an end of the rib 69 opposite to the third wall portion 68 in the Y-axis direction may be separated from the attachment member 62 at a position where locking claws 66a and 67a to be described below are provided in order to secure a deflection amount of the first wall portion 66 and the second wall portion 67. Furthermore, the end of the rib 69 opposite to the third wall portion 68 may be brought into contact with the attachment member 62 such that a position of the cover body 65 in the Y-axis direction is regulated at a position where the locking claws 66a and 67a are not provided.

The first wall portion 66 and the second wall portion 67 may have the locking claws 66a and 67a, respectively. For example, the first wall portion 66 and the second wall portion 67 have the locking claws 66a and 67a protruding so as to face each other at ends opposite to the third wall portion 68. In one example, six locking claws 66a and 67a are formed at equal intervals in the X direction (see FIG. 1). The locking claws 66a and 67a are engaged with the groove portion 63 of the attachment member 62, and thus, the cover body 65 can sandwich the attachment member 62 and be fixed to the attachment member 62. Accordingly, the cover body 65 is fixed to the sealing body 30 via the attachment member 62, and the first cover member 61 is fixed to the sealing body 30. Note that, in one example, a plurality of slits 64 extending in the Y-axis direction are formed at ends of the first wall portion 66 and the second wall portion 67 opposite to the third wall portion 68 (see FIG. 1), and thus, the locking claws 66a and 67a are easily bent in the Z-axis direction. The slits 64 may be formed so as to sandwich the locking claws 66a and 67a, for example.

As illustrated in FIG. 5, unlike the first cover member 61, the second cover member 71 as one example does not have an attachment member, and is directly fixed to the module body 1A. The second cover member 71 as one example includes a first wall portion 76 and a second wall portion 77 facing each other in the Z-axis direction, and a third wall portion 78 extending in the XZ plane so as to connect the first wall portion 76 and the second wall portion 77. A connection portion 78a between the first wall portion 76 and the third wall portion 78 and a connection portion 78b between the second wall portion 77 and the third wall portion 78 are formed in a chamfered shape similarly to the cover body 65 of the first cover member 61.

The second cover member 71 may be formed to have a hollow inside for weight reduction. In a case where the second cover member 71 has a hollow inside, one or more reinforcing ribs 79 may be provided in the hollow inside. The rib 79 has a plate shape extending along the YZ plane, and connects the first wall portion 76 and the second wall portion 77 to each other. The rib 79 in the illustrated example is further connected to the third wall portion 78. The second cover member 71 may include a plurality of ribs 79 at equal intervals in the X-axis direction (see FIG. 7). A position of an end of the rib 79 opposite to the third wall portion 78 in the Y-axis direction may be separated from the sealing body portion 20 at a position where projecting portions 76a and 77a to be described later are provided in order to secure a deflection amount of the first wall portion 76 and the second wall portion 77. Furthermore, the end of the rib 79 opposite to the third wall portion 78 may be brought into contact with the sealing body portion 20 such that a position of the second cover member 71 in the Y-axis direction is restricted at a position where the projecting portions 76a and 77a are not provided.

The first wall portion 76 and the second wall portion 77 may have projecting portions 76a and 77a, respectively. For example, the first wall portion 76 and the second wall portion 77 have projecting portions 76a and 77a facing each other at ends opposite to the third wall portion 78. In one example, three projecting portions are formed at equal intervals in the X direction. For example, the second cover member 71 can be fixed to the sealing body 30 by sandwiching the sealing body portion 20 between the projecting portions 76a and 77a. Note that, in one example, the plurality of slits 74 (see FIG. 7) extending in the Y-axis direction are formed in the ends of the first wall portion 76 and the second wall portion 77 opposite to the third wall portion 78, and thus, the projecting portions 76a and 77a are easily bent in the Z-axis direction. For example, the slits 74 may be formed so as to sandwich the projecting portions 76a and 77a.

In one example, the projecting portions 76a and 77a may be engaged with both end surfaces of the welded end 23 (see FIG. 3) in the Z-axis direction. In this case, the welded end 23 may or may not have a recess or the like with which the projecting portions 76a and 77a are engaged. In a case where the recess or the like is not formed in the welded end 23, the second cover member 71 can be fixed to the welded end 23 by sandwiching the welded end 23 while bending the projecting portions 76a and 77a.

Furthermore, in the cover member 60 as one example, the first cover member 61 and the second cover member 71 may be coupled to each other. FIG. 6 illustrates recesses 83 provided in the cover body 65 of the first cover member 61 and locking claws 81 provided in the second cover member 71. For example, the first cover member 61 and the second cover member 71 are coupled to each other by the locking claws 81 and the recesses 83 corresponding to the locking claws 81. As illustrated in FIG. 6, the second cover member 71 as one example has the locking claws 81 protruding in the X-axis direction from the first wall portion 76 and the second wall portion 77. Furthermore, on the first wall portion 66 and the second wall portion 67 of the cover body 65 of the first cover member 61, the recesses 83 recessed in the Z-axis direction are formed so as to correspond to the locking claws 81. Note that, the first cover member 61 may have the recesses 83 corresponding to the locking claws 81 of one second cover member 71 and the locking claws 81 corresponding to the recesses 83 of the other second cover member 71 (see FIG. 1).

For example, the cover body 65 and the second cover member 71 are coupled by engaging the locking claws 81 of the second cover member 71 with the recesses 83 of the cover body 65. In a state where the cover body 65 and the second cover member 71 are coupled, the first wall portion 66, the second wall portion 67, and the third wall portion 68 of the cover body 65 are flush with the first wall portion 76, the second wall portion 77, and the third wall portion 78 of the second cover member 71, respectively. Furthermore, as illustrated in FIG. 4, the first wall portion 66 of the cover body 65, the region 62a of the attachment member 62 close to the module body 1A, and the first overhang portion 55 of the reinforcing member 50 may be flush with each other, and the second wall portion 67 of the cover body 65, the region 62a of the attachment member 62, and the second overhang portion 57 of the reinforcing member 50 may be flush with each other. Furthermore, in the Y-axis direction, positions (see FIG. 5) of ends 76e and 77e of the first wall portion 76 and the second wall portion 77 of the second cover member 71 opposite to the third wall portion 78 may be the same as positions (see FIG. 4) of the end edge 55a of the first overhang portion 55 and the end edge 57a of the second overhang portion 57.

The exterior film 90 illustrated in FIGS. 4 and 5 may be, for example, a laminate film including a metal layer. That is, the exterior film 90 may be a sheet-shaped member in which at least a part of the metal layer such as aluminum is covered with a resin layer. The exterior film 90 surrounds and contains the module body 1A and the cover member 60 as a whole. Accordingly, the cover member 60 is interposed between the sealing body 30 of the module body 1A and the exterior film 90. In this configuration, the outer side surface 20sA of the module body 1A in which the liquid pouring port is provided is not in contact with the exterior film 90.

Note that, in a case where the conductive members are arranged on the positive terminal electrode 12 and the negative terminal electrode 13, the metal layer of the exterior film 90 interposed between the positive terminal electrode 12 and the conductive member and between the negative terminal electrode 13 and the conductive member may be exposed from the resin layer. Accordingly, it is possible to extract current from the electric power storage module 1 by using the conductive members. Note that, the entire metal layer of the exterior film 90 may be covered with the resin layer, and then current may be extracted from the electric power storage module 1 by a terminal connected to the positive terminal electrode 12 and the negative terminal electrode 13.

As described above, the electric power storage module 1 as one example includes the electrode stack 10 in which the plurality of electrodes each including the current collector 15 are stacked in the Z-axis direction, the sealing body 30 provided in the electrode stack 10 so as to surround the electrode stack 10 as viewed from the Z-axis direction and configured to seal the plurality of internal spaces S formed between the current collectors 15 adjacent in the Z-axis direction, the exterior film 90 surrounding and containing the electrode stack 10 and the sealing body 30, and the cover member 60 contained in the exterior film 90 so as to be interposed between the sealing body 30 and the exterior film 90, covering the outer side surface 20s extending in the Z-axis direction of the sealing body 30, and fixed to the sealing body 30.

In the electric power storage module 1, the cover member 60 is interposed between the sealing body 30 and the exterior film 90, and the cover member 60 is fixed not to the electrode stack 10 but to the sealing body 30 surrounding the electrode stack 10. As described above, since the cover member 60 is not directly fixed to the electrode stack 10, deformation and damage of the electrode stack 10 by the cover member 60 are suppressed. Furthermore, in the above example, since the cover member 60 that can be in contact with the exterior film 90 has the connection portions 68a and 68b formed in the chamfered shape, the damage of the exterior film 90 is suppressed.

The sealing body 30 as one example may have the plurality of communication holes 27 formed so as to communicate with the plurality of internal spaces S and have the openings 52 on the side surface, and the protruding frame portion 53 protruding in the Y-axis direction from the outer side surface 20sA so as to surround the openings 52 of the plurality of communication holes 27, and the cover member 60 may cover the protruding frame portion 53. In this configuration, since the contact of the protruding frame portion 53 with the exterior film 90 is suppressed, the deformation and damage of the exterior film 90 by the protruding frame portion 53 are suppressed. Furthermore, since wrinkles are hardly formed on the exterior film 90, the damage of the exterior film 90 is suppressed when expansion and contraction of the electric power storage module 1 occur.

The cover member 60 as one example may be fixed to the protruding frame portion 53. In this configuration, the contact of the protruding frame portion 53 with the exterior film 90 is suppressed. Note that, the fixing may be a concept including welding, sandwiching adhesion, and the like. In the embodiment, an example in which the cover member 60 is welded to the protruding frame portion 53 is illustrated. For example, in a case where the cover member 60 is fixed by sandwiching the protruding frame portion 53 from the Z-axis direction, it is conceivable that the protruding frame portion 53 is deformed over time. In a case where the cover member 60 is welded to the protruding frame portion 53, the deformation of the protruding frame portion 53 is suppressed.

The cover member 60 as one example may include the attachment member 62 welded to the protruding frame portion 53 and the cover body 65 that sandwiches the attachment member 62 from the Z-axis direction. In this configuration, the attachment member 62 is provided as a dedicated component to be welded to the protruding frame portion 53, and thus, the protruding frame portion 53 can be reliably sealed.

The cover member 60 may include the first cover member 61 covering the region R1 of the outer side surface 20sA where the protruding frame portion 53 is formed and the second cover member 71 covering the region R2 of the outer side surface 20sA where the protruding frame portion 53 is not formed, and the first cover member 61 and the second cover member 71 may be coupled to each other. A different cover member is used for each region, and thus, the outer side surface 20sA can be easily covered. Furthermore, the cover member is divided into a plurality of parts, and thus, occurrence of warpage or the like in each cover member is suppressed.

Furthermore, in the Y-axis direction, since the positions of the ends 76e and 77e of the first wall portion 76 and the second wall portion 77 of the second cover member 71 are the same as the positions of the end edge 55a of the first overhang portion 55 and the end edge 57a of the second overhang portion 57, formation of a step between the second cover member 71 and the overhang portion is suppressed. In this case, since the wrinkles are hardly formed on the exterior film 90, the damage of the exterior film 90 is suppressed when the expansion and contraction of the electric power storage module 1 occur.

Examples of each embodiment of the present disclosure has been described above with reference to the drawings, but the present disclosure is not limited to the above embodiment.

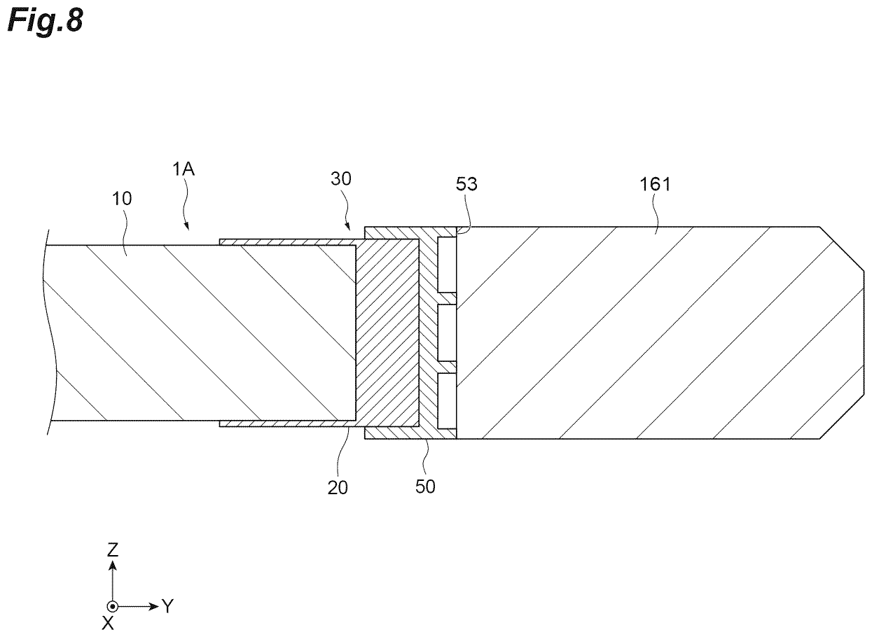

FIG. 8 is a schematic sectional view of an electric power storage module as another example. FIG. 8 is a sectional view of the electric power storage module at a position where a first cover member 161 as a modification of the first cover member 61 is provided. Note that, in FIG. 8, the exterior film 90 is omitted. The first cover member 161 may have a substantially rectangular plate shape. A size of the first cover member 161 in the Z-axis direction may be the same as the size of the reinforcing member 50 in the Z-axis direction. Furthermore, the size of the first cover member 161 in the X-axis direction may be equal to the size of the reinforcing member 50 in the X-axis direction. The first cover member 161 does not have an attachment member, and is welded to the reinforcing member 50. In the illustrated example, the first cover member 161 is welded to the protruding frame portion 53 of the reinforcing member 50. Note that, similarly to the cover body 65, the first cover member 161 may have a hollow inside, or may not have a space inside.

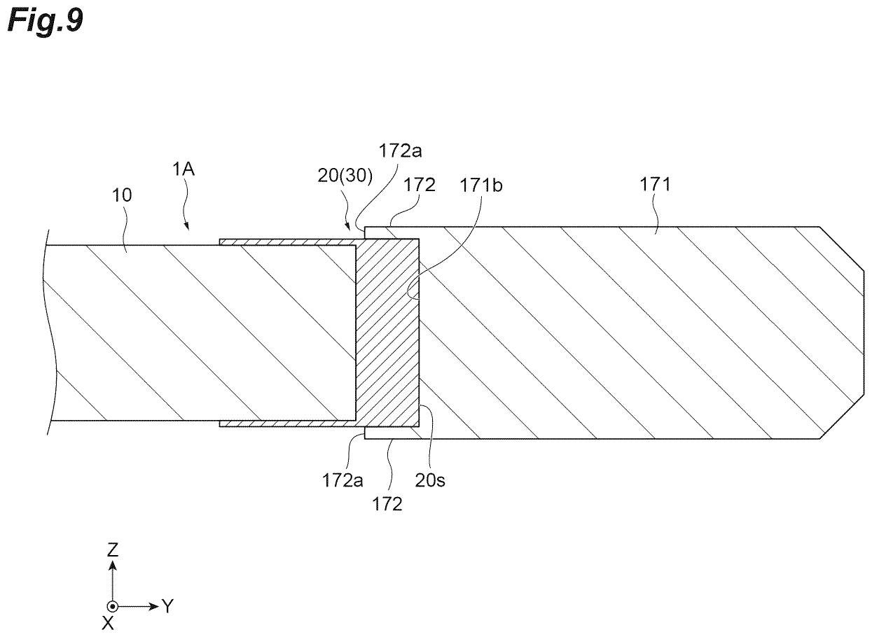

FIG. 9 is a schematic sectional view of an electric power storage module as yet another example. FIG. 9 is a sectional view of the electric power storage module at a position where a second cover member 171 as a modification of the second cover member 71 is provided. Note that, in FIG. 9, the exterior film 90 is omitted. The second cover member 171 may have a pair of protruding pieces 172 protruding in the Y-axis direction from both ends in the Z-axis direction. In a state where the sealing body portion 20 is inserted between the protruding pieces 172, the outer side surface 20s and a side surface 171b of the second cover member 171 facing the outer side surface 20s are welded. In this state, a position of an end 172a of the protruding piece 172 may be the same as the positions of the end edge 55a of the first overhang portion 55 and the end edge 57a of the second overhang portion 57 (see FIG. 4).

FIG. 10 is a schematic sectional view of an electric power storage module as yet another example. FIG. 10 is a sectional view of the electric power storage module at a position where a second cover member 271 as a modification of the second cover member 71 is provided. Note that, in FIG. 10, the exterior film 90 is omitted. The second cover member 271 includes a first wall portion 276 and a second wall portion 277 facing each other in the Z-axis direction, a third wall portion 278 extending in the XZ plane so as to connect the first wall portion 276 and the second wall portion 277, and a reinforcement rib 279. The first wall portion 276 and the second wall portion 277 may have locking claws 276a and 277a, respectively. For example, the first wall portion 276 and the second wall portion 277 have the locking claws 276a and 277a protruding so as to face each other at ends opposite to the third wall portion 278. For example, groove portions 223 formed along the X-axis direction may be formed on both end surfaces of the sealing body portion 20 in the Z-axis direction, and the second cover member 271 may sandwich the sealing body portion 20 and be fixed to the sealing body portion 20 by engaging the locking claws 276a and 277a with the groove portions 223.

Furthermore, the exterior film 90 is not limited to a laminate film including a metal layer and a resin layer. For example, the exterior film 90 may be a laminate film made of a resin film not including a metal layer. Such a resin film may include a resin layer having low moisture permeability.

Furthermore, after the module body 1A is contained in the exterior film 90, an inside of the exterior film 90 may be sealed in a decompressed state. In this configuration, the exterior film 90 pressed by an atmospheric pressure is brought into close contact with the module body 1A. In this case, it is conceivable that a protruding portion such as the protruding frame portion 53 in the sealing body 30 damages the exterior film 90, but such damage can be suppressed by providing the cover member 60.

Furthermore, three outer side surfaces 20s other than the outer side surface 20sA on which the protruding frame portion 53 is not provided may be covered with a cover member similar to the second cover member 71. For example, among the three outer side surfaces 20s other than the outer side surface 20sA, the cover member may be provided only on the outer side surface 20s arranged to face the outer side surface 20sA, the cover member may be provided on one or both of the two outer side surfaces 20s orthogonal to the outer side surface 20sA, or the cover member may be provided on all of the three outer side surfaces 20s. The cover member may cover the entire surface or a part of the outer side surface 20s.

Furthermore, although the example in which the outer side surface 20sA is covered with one first cover member 61 and two second cover members 71 has been described, the outer side surface 20sA may be covered with only the second cover member. For example, extended portions extending in the X-axis direction are provided between facing ends of the pair of second cover members provided with the protruding frame portion 53 interposed therebetween, and thus, the extended portions may form an outer shape similar to the first cover member 61 to cover the protruding frame portion 53. In this case, the opening of the protruding frame portion 53 may be sealed with a sealing film or the like.

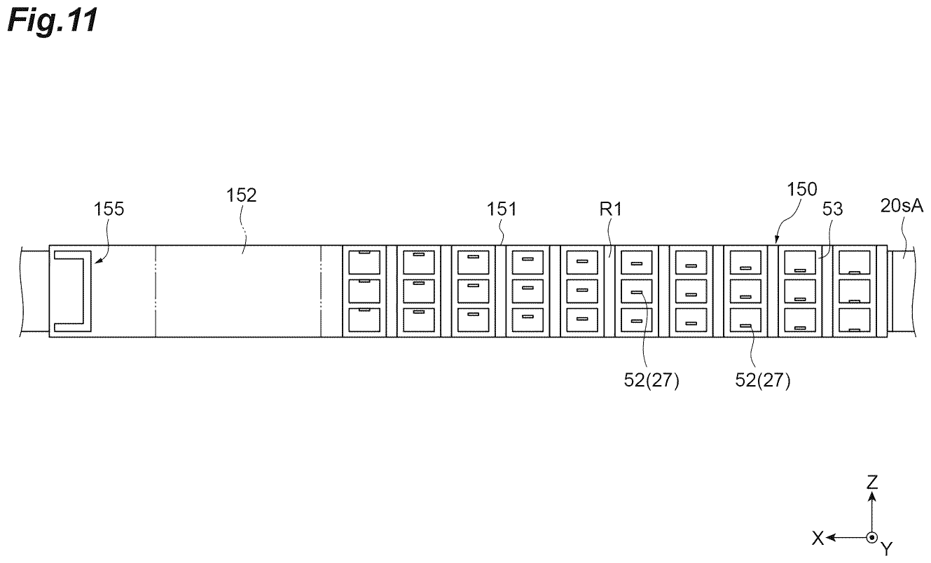

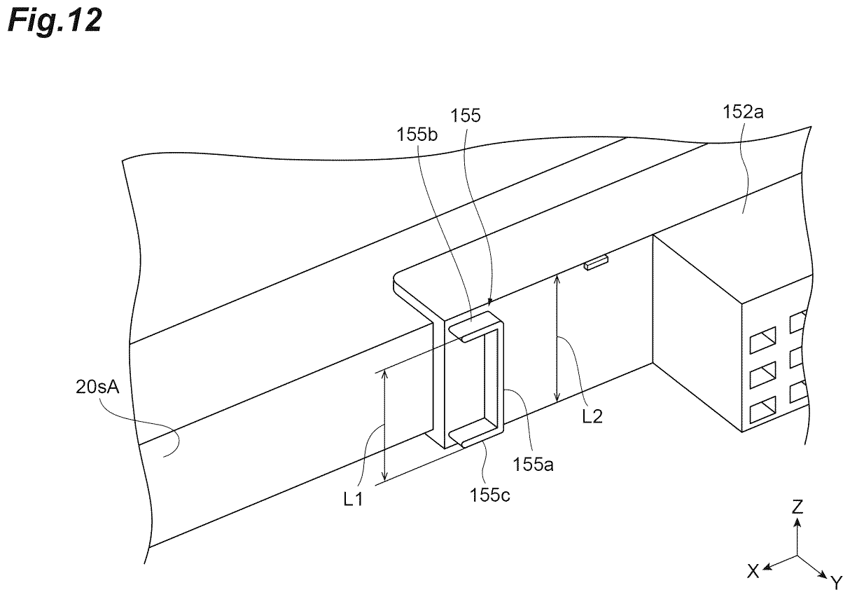

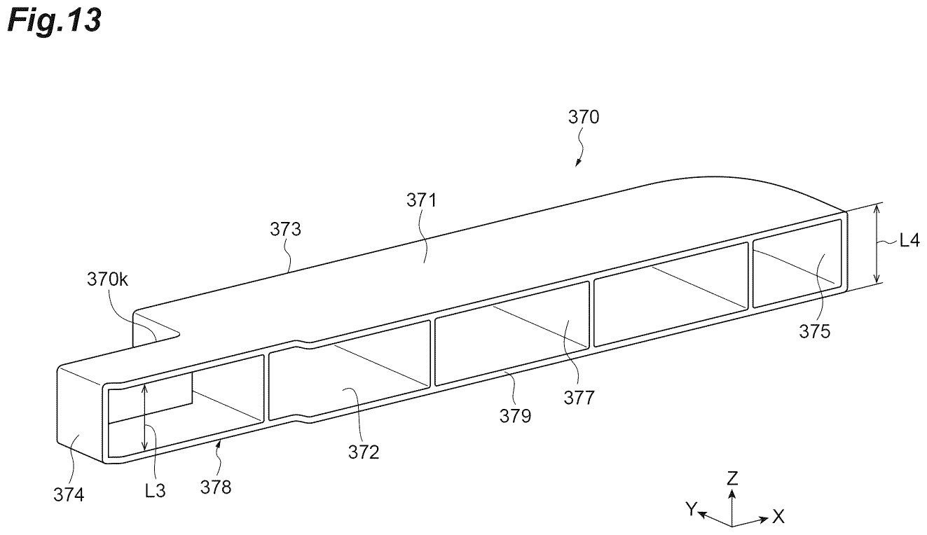

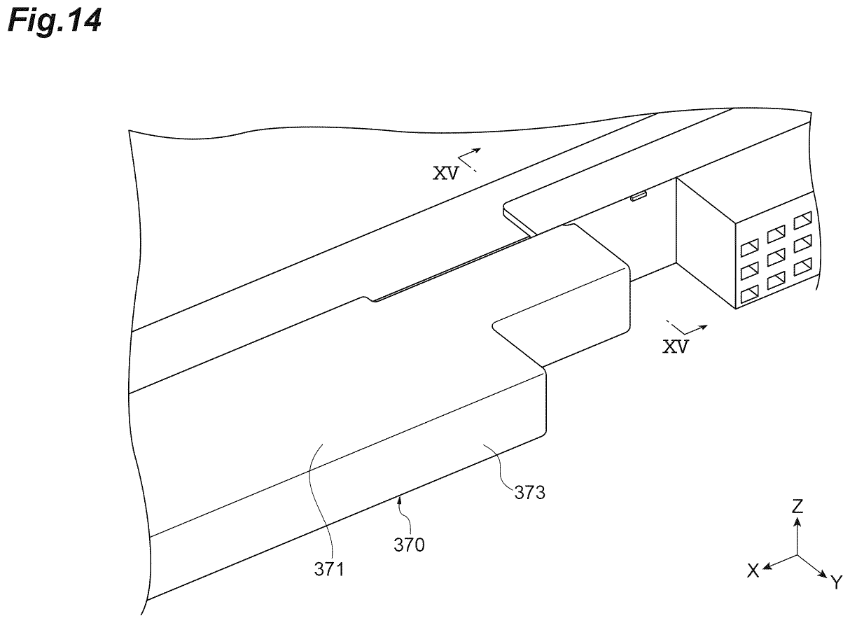

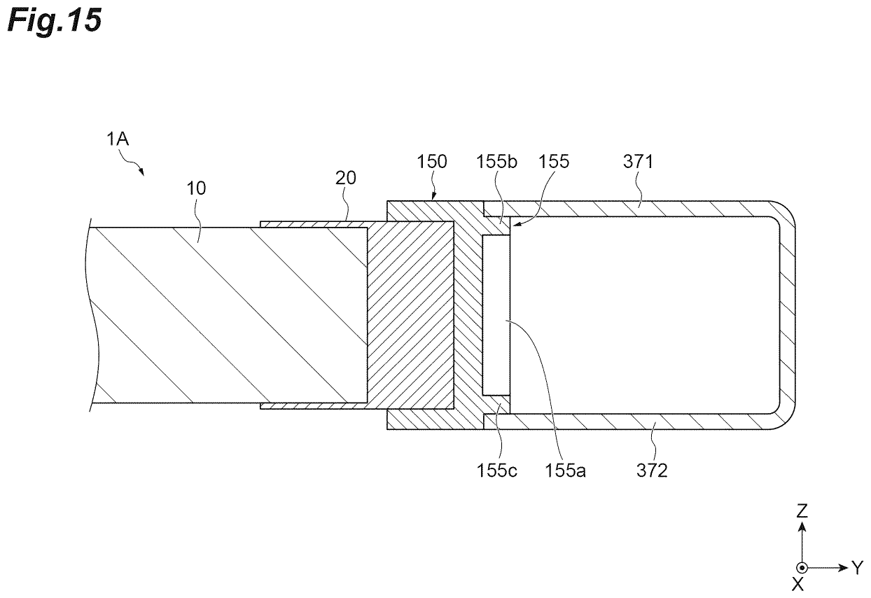

Yet another electric power storage module will be described with reference to FIGS. 11 to 15. FIG. 11 is a schematic diagram illustrating a side surface of a module body constituting yet another electric power storage module. FIG. 12 is a perspective view illustrating a part of the side surface of the module body of FIG. 11. FIG. 13 is a perspective view illustrating a cover member as another example. FIG. 14 is a perspective view illustrating a state where the cover member of FIG. 13 is attached to the module body. FIG. 15 is a sectional view taken along line XV-XV of FIG. 14.

In FIGS. 11 to 15, a reinforcing member 150 having a shape different from the reinforcing member 50 is illustrated, and a cover member 370 engaged with the reinforcing member 150 is illustrated. The cover member 370 is, for example, a member corresponding to the second cover member 71 in the above embodiment. As illustrated in FIG. 11, the reinforcing member 150 has a body portion 151 partially covering the outer side surface 20sA. The body portion 151 has a protruding frame portion 53 similarly to the body portion 51 described above. Furthermore, the reinforcing member 150 includes a terminal portion 152 for voltage detection. The terminal portion 152 is formed at a position shifted to a positive side in the X-axis direction from the plurality of protruding frame portions 53 in the body portion 151. The terminal portion 152 can provide a plurality of terminals electrically connected to the plurality of current collectors 15. Connector unit 152a (see FIG. 12) electrically connected to the plurality of terminals can be fixed to the terminal portion 152.

In the body portion 151, an engagement portion 155 to be engaged with the cover member 370 is formed at a position shifted to the positive side in the X-axis direction from the terminal portion 152. In the illustrated example, the engagement portion 155 is formed at an end of the body portion 151 in the X-axis direction. The engagement portion 155 may be fitted to the cover member 370. The engagement portion 155 as one example protrudes from the body portion 151 along the Y direction. As illustrated in FIG. 12, the engagement portion 155 includes a central portion 155a extending along the Z-axis direction and a pair of side portions 155b and 155c connected to both ends of the central portion 155a in the Z-axis direction. The side portions 155b and 155c extend toward the positive side in the X-axis direction with the central portion 155a as a base end. In a case where the Z-axis direction is an upper-lower direction, a distance L1 along the Z-axis direction from an upper surface of the side portion 155b positioned on an upper side to a lower surface of the side portion 155c positioned on a lower side is shorter than a length L2 of the body portion 151 in the Z-axis direction.

The cover member 370 includes a first wall portion 371 and a second wall portion 372 facing each other in the Z-axis direction, and a third wall portion 373 extending in the XZ plane so as to connect the first wall portion 371 and the second wall portion 372. Furthermore, the cover member 370 includes a fourth wall portion 374 and a fifth wall portion 375 which extend in the YZ plane so as to connect the first wall portion 371, the second wall portion 372, and the third wall portion 373, and face each other in the X-axis direction. In the cover member 370 of the illustrated example, a connection portion between the third wall portion 373 and the fifth wall portion 375 is curved in an arc shape from the Z-axis direction.

Furthermore, in the cover member 370 of the illustrated example, corner portions 370k of the first wall portion 371 and the second wall portion 372 connected to the third wall portion 373 and the fourth wall portion 374 are formed in an inner corner shape.

One or more reinforcing ribs 377 are provided inside a hollow shape of the cover member 370. The rib 377 has a plate shape extending along the YZ plane, and connects the first wall portion 371, the second wall portion 372, and the third wall portion 373 to each other. The plurality of ribs 377 may be arranged at equal intervals in the X-axis direction. As an example, the interval between the adjacent ribs 377 is larger than an interval between the first wall portion 371 and the second wall portion 372. End surfaces of the first wall portion 371, the second wall portion 372, the fourth wall portion 374, the fifth wall portion 375, and the rib 377 facing a side opposite to the third wall portion 373 constitute a wall surface 379 facing the third wall portion 373.

In the first wall portion 371 and the second wall portion 372 of the illustrated example, a cutout portion 378 that avoids interference with an end of the reinforcing member 150 is formed near the fourth wall portion 374. For example, the cutout portion 378 is formed by recessing a position of the wall surface 379 in the Y-axis direction toward the third wall portion 373. In one example, when the reinforcing member 150 is formed by injection molding, resin may extrude from the body portion 151 of the reinforcing member 150 along the outer side surface 20sA, but in this case, the resin portion extruding into a space formed by the cutout portion 378 may be contained.

In one example, a distance L3, which is an inner dimension between the first wall portion 371 and the second wall portion 372, may be the same as the distance L1, which is an outer dimension between the pair of side portions 155b and 155c of the engagement portion 155. Note that, the distance L3 and the distance L1 do not need to be exactly the same, and may be substantially the same. For example, the distance L3 in the cover member 370 in a non-fitted state may be the same as or slightly smaller than the distance L1. Furthermore, an outer dimension L4 between the first wall portion 371 and the second wall portion 372 may be the same as the length L2 of the body portion 151 in the Z-axis direction.

As illustrated in FIGS. 14 and 15, the cover member 370 is engaged with the engagement portion 155 formed in the body portion 151 of the reinforcing member 150. In one example, the cover member 370 is engaged with the engagement portion 155 by fitting the pair of side portions 155b and 155c of the engagement portion 155 between the first wall portion 371 and the second wall portion 372. In a state where the cover member 370 is engaged with the engagement portion 155, the first wall portion 371 and the second wall portion 372 may be flush with the first overhang portion 55 and the second overhang portion 57, respectively.

As described above, the outer side surface 20sA has the engagement portion 155 engaged with the cover member 370, and thus, the cover member 370 can be stably attached to the module body 1A. Furthermore, since the engagement portion 155 is formed in the reinforcing member 150, application of an excessive load to the welded end 23 is suppressed. Note that, although the example in which the engagement portion 155 protrudes in the Y-axis direction has been described, for example, a recess recessed in the Y direction may be formed in the reinforcing member 150, and a protrusion fitted into the recess may be formed in the cover member. Furthermore, the cover member 370 and the engagement portion 155 may further include claws that are engaged with each other. Furthermore, although the example in which the engagement portion 155 is fitted between the first wall portion 371 and the second wall portion 372 facing each other in the Z-axis direction has been described, the engagement portion 155 may be fitted between the wall portions facing each other in the X-axis direction. For example, the cover member 370 may have a pair of ribs 377 so as to sandwich the engagement portion 155 from the X-axis direction. In this case, the engagement portion 155 may have a pair of side portions extending along the YZ plane so as to be brought into contact with the pair of ribs 377.

### REFERENCE SIGNS LIST

1 Electric Power Storage Module
10 electrode stack
11 bipolar electrode (electrode)
12 positive terminal electrode (electrode)
13 negative terminal electrode (electrode)
15 current collector
20s outer side surface (side surface)
27 communication hole
50 reinforcing member
53 protruding frame portion (frame portion)
60 cover member
61 first cover member
71 second cover member
90 exterior film
S internal space

1. An electric power storage module comprising:
an electrode stack in which a plurality of electrodes each including a current collector are stacked in a first direction;
a sealing body provided on the electrode stack so as to surround the electrode stack as viewed from the first direction and configured to seal a plurality of internal spaces formed between the electrodes adjacent to each other in the first direction;
an exterior film configured to surround and contain the electrode stack and the sealing body; and
a cover member contained in the exterior film so as to be interposed between the sealing body and the exterior film, configured to cover a side surface of the sealing body extending in the first direction, and fixed to the sealing body.

2. The electric power storage module according to claim 1, wherein the sealing body includes
a plurality of communication holes configured to communicate with the plurality of internal spaces and formed to have openings in the side surface, and
a frame portion configured to protrude from the side surface in a second direction intersecting the side surface so as to surround the openings of the plurality of communication holes, and
the cover member covers the frame portion.

3. The electric power storage module according to claim 2, wherein the cover member is fixed to the frame portion.

4. The electric power storage module according to claim 3, wherein the cover member includes an attachment member welded to the frame portion, and a cover body fixed to the attachment member by sandwiching the attachment member.

5. The electric power storage module according to claim 2, wherein
the cover member includes a first cover member configured to cover a region of the side surface where the frame portion is formed, and a second cover member configured to cover a region of the side surface where the frame portion is not formed, and
the first cover member and the second cover member are coupled to each other.

6. The electric power storage module according to claim 1, wherein
the sealing body includes an engagement portion protruding from the side surface in a second direction intersecting the side surface,
the cover member has a pair of wall portions facing each other, and
the engagement portion is engaged between the pair of wall portions.

7. The electric power storage module according to claim 6, wherein, in the first direction, an inner dimension between the pair of wall portions is equal to an outer dimension of the engagement portion.
